(19) United States
(12) Patent Application Publication
(10) Pub. No.: US 2025/0354948 A1
(43) Pub. Date: Nov. 20, 2025

(54) MEASURING DEVICE AND METHOD FOR DETERMINING AND OUTPUTTING THE DEW POINT TEMPERATURE OF AN AMBIENT MEDIUM

(71) Applicant: E+E Elektronik Ges.m.b.H., Engerwitzdorf (AT)

(72) Inventors: Herbert Enser, Linz (AT); Joachim Gratzl, Leonding (AT); Albin Haider, Alberndorf (AT); Karl Jahn, Gunskirchen (AT)

(21) Appl. No.: 19/204,663

(22) Filed: May 12, 2025

(30) Foreign Application Priority Data
May 15, 2024 (DE) 102024001578. 7

(51) Int. Cl. G01N 25/66

(52) U.S. Cl. CPC G01N 25/66

(57) ABSTRACT

A measuring device for determining and outputting a dew point temperature of an ambient medium, including a first and second humidity sensor unit and a controller. The first humidity sensor unit is configured to determine at least one dew point correction parameter and includes a first humidity sensor, a first temperature sensor and a temperature change element. The second humidity sensor unit, which is configured to continuously determine a dew point temperature and includes a second humidity sensor and a second temperature sensor. The controller is configured and arranged to change a temperature of the first humidity sensor unit via the temperature change element and thereby determine the dew point correction parameter, and use the dew point correction parameter from the first humidity sensor unit to correct measured values of the second humidity sensor unit and to continuously output corrected dew point temperatures based on the corrected measured values.

### CROSS REFERENCE TO RELATED APPLICATIONS

This application claims benefit to German Patent Application No. DE 102024001578. 7, filed on May 15, 2024, which is hereby incorporated by reference herein.

### FIELD

The present invention relates to a measuring device and a method for determining and outputting the dew point temperature of an ambient medium.

### BACKGROUND

Measuring the dew point of gases represents an important process engineering and meteorological measurement task. The dew point and/or dew point temperature indicate the gas temperature above which the water contained in the gas condenses and/or it refers to the gas temperature at which a gas over a water surface is completely saturated with water vapor. In some cases, a dew point temperature below 0° C. is also referred to as the frost point temperature; the frost point temperature thereby refers to the temperature at which a gas over an ice surface is fully saturated with water vapor. The dew point, on the other hand, refers to the temperature at which the gas over a water surface is fully saturated. In the following, only the dew point temperature shall be referred to, even for dew point temperatures below 0° C.

If condensation occurs in compressed air systems, for example, this results in damage to the system and loss of quality in the end product. In building services engineering, measuring devices for determining the dew point temperature (dew point measuring devices, dew point monitors) are used to detect the risk of condensation formation in time before damage occurs, for example in climate ceilings, pipelines or switch cabinets. The measurement of the dew point temperature is usually not performed directly, but rather through the measurement of the temperature and relative humidity and the appropriate calculation of these values.

If capacitive humidity sensors are used to measure relative humidity, it can be beneficial in several ways to cyclically heat these humidity sensors.

For example, this may be necessary with permanently high humidity values above 80% rH, as capacitive humidity sensors show a so-called high humidity drift. This means that at high relative humidity values, the humidity sensor indicates excessively high humidity values over an extended period of time, resulting in excessively high dew point temperatures.

In the case of low dew point temperatures, only very small measured values regarding the relative humidity need to be captured. This results in high demands on the accuracy of the humidity measurement. When using capacitive humidity sensors, the change in capacitance of a suitable polymer is usually used as the measured variable for the relative humidity. To repeatedly bring the polymer used into a defined calibration state during a measurement, it is common practice to cyclically heat the measuring device, for example every 30 minutes.

Furthermore, cyclical heating of the humidity sensor may become necessary when it is used in chemically invasive environments with mixed gases that can be deposited in the humidity polymer instead of water molecules. This also leads to changes in capacitance that cannot be distinguished from changes in capacitance caused by humidity. In this case, the humidity sensor can always be returned to a defined calibration state via the cyclical heating. This can also be advantageous, for example, with humidity sensors that are not based on capacitive detection principles.

However, this type of cyclical heating has certain consequences for dew point measurement. Thus, for example, no measured values for determining the dew point temperature are available for the duration of the heating and cooling phase; the corresponding time period may thereby possibly extend over several minutes. Furthermore, even after cooling down, it takes a certain amount of time before the current dew point temperature can be correctly captured again. The dew point temperature is then again only determined correctly for a limited time, after which the dew point temperature drifts towards excessively high values. In this context, this is also referred to as a “sawtooth effect” in relation to the temporal progression of the dew point determination.

The behavior explained above is shown in the diagram in FIG. 1. This shows the progression of the measured dew point temperature over an extended time period, during which a capacitive humidity sensor is heated up and/or baked out every 30 minutes; furthermore, the correct dew point temperature, or the target value of the dew point temperature is depicted as a continuous horizontal line in the figure. As can be seen from the figure, the heating process is followed by a cooling phase during which the humidity sensor returns to the ambient temperature and during which no correct dew point temperature can be determined. After the cooling phase, it then takes a certain amount of time before the correct dew point temperature can be determined again. After some time, the dew point temperature moves towards exceedingly high values due to the change in the humidity-sensitive polymer, until heating up occurs again, and after a new cooling phase, the correct dew point temperature can be determined again for a certain measuring period, and so on.

A possible procedure for minimizing errors in a sensor arrangement with several capacitive sensor units that occur due to the cyclical heating of these sensor units is known from JP 2012-154632 A2. The alternating heating of two sensor units is therefore intended to avoid errors caused by contamination of the polymer and/or by a drift of the measured values at very high humidity levels. However, the aforementioned problems in dew point measurement, especially at low dew point temperatures, cannot be eliminated by the measures known from this document.

### SUMMARY

In an embodiment, the present disclosure provides a measuring device for determining and outputting a dew point temperature of an ambient medium, comprising a first humidity sensor unit, a second humidity sensor unit, and a controller. The first humidity sensor unit is configured to determine at least one dew point correction parameter and comprises a first humidity sensor, a first temperature sensor and a temperature change element. The second humidity sensor unit, which is configured to continuously determine a dew point temperature and comprises a second humidity sensor and a second temperature sensor. The controller is configured and arranged to change a temperature of the first humidity sensor unit via the temperature change element and thereby determine the dew point correction parameter, and use the dew point correction parameter from the first humidity sensor unit to correct measured values of the second humidity sensor unit and to continuously output corrected dew point temperatures based on the corrected measured values.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a sawtooth effect that occurs when determining a dew point temperature;

FIG. 2 illustrates a highly schematized block diagram of an exemplary embodiment of a measuring device according to the present disclosure;

FIG. 3a illustrates an exploded view of a sensor-side part of an embodiment of the measuring device according to the present disclosure;

FIG. 3b illustrates a part of the measuring device according to the present disclosure in an assembled condition;

FIG. 3c and FIG. 3d illustrate in each case different views of the sensor-side part of the measuring device according to the present disclosure;

FIG. 4a illustrates an exploded view of the sensor-side part of an embodiment of the measuring device according to the present disclosure;

FIG. 4b illustrates a part of the measuring device according to the present disclosure in an assembled condition;

FIG. 4c illustrates a lateral view of the sensor-side part of the measuring device according to the present disclosure;

FIG. 5 illustrates a method according to the present disclosure;

FIG. 6 illustrates a diagram showing dew point temperatures determined by two humidity sensor units during different phases; and

FIG. 7 illustrates diagram illustrating a temperature curve when determining a dew point correction parameter.

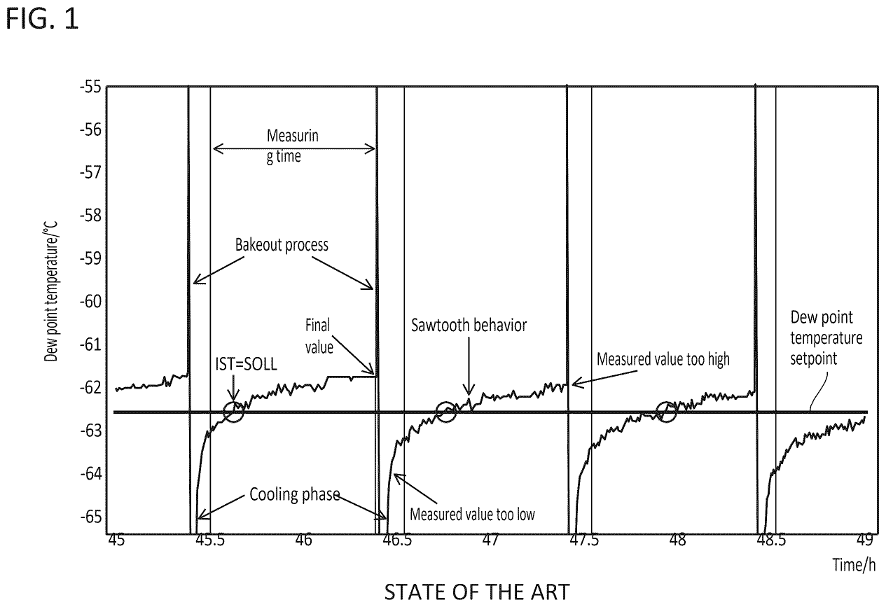

### DETAILED DESCRIPTION

In an embodiment, the present disclosure provides a measuring device and a method for determining and outputting the dew point temperature of an ambient medium, which are particularly suitable for measuring low dew point temperatures. A reliable determination of the dew point temperature of the ambient medium should thereby be ensured as consistently as possible.

The measuring device according to the present disclosure for determining and outputting the dew point temperature of an ambient medium exhibits a first humidity sensor unit, which is configured to determine at least one dew point correction parameter and comprises a first humidity sensor, a first temperature sensor and a temperature change element. Furthermore, a second humidity sensor unit is provided, which is configured to continuously determine the dew point temperature and comprises a second humidity sensor and a second temperature sensor. A control unit is configured and arranged in such a way as to change the temperature of the first humidity sensor unit via the temperature change element and to determine a dew point correction parameter in the process. The dew point correction parameter from the first humidity sensor unit is used by the control unit to correct measured values of the second humidity sensor unit and to continuously output corrected dew point temperatures based on the corrected measured values.

Preferably, the second humidity sensor unit is thermally coupled with a cooling element that dissipates heat from the second humidity sensor unit to the environment.

Advantageously, the second humidity sensor unit is thermally decoupled from the first humidity sensor unit.

Furthermore, it can be provided:
that the two humidity sensor units are disposed at the opposite ends of a carrier element, which is formed with reduced material in the area between the two humidity sensor units for thermal decoupling, and
that the carrier element is surrounded by a housing that has several opening windows.

Furthermore, it is possible that the two humidity sensor units are disposed on two separate carrier elements, between which a heat conducting shield is disposed, which diverts the heat transferred to it by thermal radiation in the direction of a connected heat sink.

Preferably, a heat sink made of a material with good thermal conductivity is disposed on the carrier element adjacent to the second humidity sensor unit as a cooling element.

Furthermore, at least one carrier element can exhibit an electrical connection for connection to the control unit to transmit data and control signals between the humidity sensor units and the control unit.

In an advantageous embodiment, the two humidity sensor units are configured as integrated components.

For a method according to the present disclosure for determining and outputting the dew point temperature of an ambient medium, a first humidity sensor unit is provided, from the measured values of which at least one dew point correction parameter is determined with respect to temperature and relative humidity. Furthermore, a second humidity sensor unit is provided, from whose measured values with respect to temperature and relative humidity a dew point temperature is continuously determined and output. The temperature of the first humidity sensor unit is changed and a dew point correction parameter is determined in each case, and the dew point correction parameter is used to correct a measured value of the second humidity sensor unit and to continuously output corrected dew point temperatures based on the corrected measured values.

Preferably, the changing of the temperature and the determination of at least one dew point correction parameter occur cyclically.

For this purpose, it can be provided that, in order to determine the at least one dew point correction parameter, the respective dew point temperatures are determined from the respectively measured temperatures and relative humidities via the first humidity sensor unit at at least two defined points in time at different temperatures and, if the two dew point temperatures do not match, a measured value is corrected with respect to relative humidity such that the dew point temperatures at the different temperatures match.

It is also possible that to determine the at least one dew point correction parameter via the first sensor unit:
the respective dew point temperatures are determined at at least two defined points in time at different temperatures from the respective measured temperatures and relative humidities, and
an ideal relative humidity is determined from the ascertained dew point at the lower temperature and the measured higher temperature, and
a first humidity correction parameter is determined from the difference between the ideal relative humidity and the measured relative humidity at the higher temperature, and
the dew point correction parameter is determined in the form of an absolute dew point value with the aid of the first humidity correction parameter, and
the absolute dew point value is used in order to determine a second humidity correction parameter, which is subsequently, together with the measured values relating to relative humidity of the second humidity sensor unit, reconciled with the corrected measured values relating to relative humidity in order to output continuously corrected dew point temperatures.

Furthermore, the reconciliation of the second humidity correction parameter with the measured values of the second humidity sensor unit regarding relative humidity can be carried out incrementally.

Advantageously, the first humidity sensor unit runs cyclically through a heating phase, a cooling phase and a measuring phase, whereby the dew point temperature is continuously determined in all phases via the second humidity sensor unit and a corrected dew point temperature is output.

The measures according to the present disclosure now ensure that a reliable determination of the dew point temperature is possible continuously over the entire measurement duration. There are no time windows in which no current value of the dew point temperature is available; it is therefore possible to react quickly to a change in the dew point temperature at any time in the respective application.

Furthermore, it is ensured that the aforementioned “sawtooth effect” in the dew point temperature determination, resulting from the cyclic bake out of the humidity sensor, can be eliminated, thus enabling the dew point temperature to be determined with consistently high accuracy.

The sensor-side part of the measuring device according to the present disclosure can be integrated into a so-called sensor probe, and no additional sensors are required. This allows the device to be used very easily in different applications.

Further details and advantages of the present disclosure are explained with reference to the following description of exemplary embodiments in conjunction with the figures.

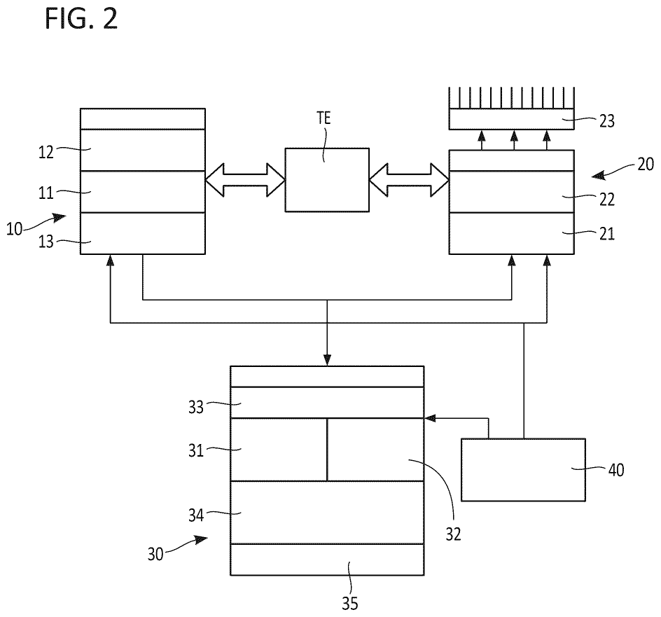

Based on the highly schematized block diagram in FIG. 2, the basic structure of the measuring device according to the present disclosure for determining and outputting the dew point temperature of a medium is explained below. The medium that surrounds the measuring device for typical measuring tasks is usually air or other gases.

The measuring device according to the present disclosure comprises a first humidity sensor unit 10, a second humidity sensor unit 20 and a control unit 30. The reference numeral 40 denotes a power supply unit which supplies the various components of the device with current and/or voltage. TE schematically indicates an element that is intended to symbolize certain measures for thermal decoupling between the first and second humidity sensor units 10, 20; more detailed explanations on this will follow in the course of the description.

The first humidity sensor unit 10 is configured to determine a dew point temperature Td_{absolute}, which also serves as a dew point correction parameter, as will be explained in detail below. For this purpose, the first humidity sensor unit 10 exhibits a first humidity sensor 11, a first temperature sensor 12 as well as a temperature change element 13.

The humidity sensor 11 can thereby, for example, be configured as a capacitive humidity sensor 11 in a known manner and can consist of two electrodes, between which there is a polymer that changes its capacitance depending on the humidity. The temperature sensor 12 is also configured in a known manner, e.g. as a temperature-dependent resistor or as a semiconductor element. As the temperature change element 13, for example, a heating element in the form of a heating wire or a semiconductor element can be used. Furthermore, the temperature change element 13 could also be configured as a Peltier element, which can be operated both in a heating mode and in a cooling mode and thus enabling a change in the temperature of the first humidity sensor unit 10.

In an embodiment, the first humidity sensor unit 10 is configured as an integrated component and/or ASIC, marketed by the applicant under the designation HTE501; this ASIC enables high-resolution and thus very accurate humidity measurement.

The second humidity sensor unit 20 is configured to continuously determine the dew point temperature and comprises a second humidity sensor 21 and a second temperature sensor 22; furthermore, in the example shown, the second humidity sensor unit 20 is thermally coupled to a cooling element 23, via which heat can be dissipated from the second humidity sensor unit 20 to the environment. The second humidity sensor unit 20 is basically configured identically to the first humidity sensor unit 10 regarding the humidity and temperature sensor 21, 22 and is preferably also configured as an integrated component and/or ASIC. As cooling element 23 a heat sink made of a material with good thermal conductivity can be used which, for example, has suitably configured cooling fins to ensure heat transfer to the ambient medium. In an advantageous embodiment, the thermal resistance of the cooling element 23 is selected to be smaller by a factor of 100 (or greater) than the thermal resistance between the first humidity sensor unit 10 and the second humidity sensor unit 20. For example, if the cooling element 23 has a thermal resistance of 30K/W to the environment, the thermal decoupling and/or the thermal resistance between the humidity sensor units 10, 20 is at least 3000K/W. In principle, the cooling element 23 is not a mandatory component of the device according to the present disclosure, but it can significantly improve its properties.

Between the two humidity sensor units 10, 20, an element labeled TE is schematically indicated; this is intended to express that the two humidity sensor units 10, 20 are disposed as thermally decoupled from each other as possible. This is understood to mean that as little heat as possible is transferred from the first humidity sensor unit 10 to the second humidity sensor unit 20 and/or that as little thermal crosstalk as possible results between the two humidity sensor units 10, 20. Such thermal decoupling TE can be ensured constructively in various ways; suitable options and measures for this are explained in more detail below in the course of the description of exemplary embodiments.

The control unit 30 is configured, for example, as a microcontroller and has various functional components, which are only indicated highly schematized in FIG. 2, and which can be implemented in various forms in terms of software and/or hardware. For communication with the two humidity sensor units 10, 20, the control unit 30 has a communication interface 33, for example configured as an I2C interface, via which data and control signals can be transmitted. Furthermore, a first and a second calculation unit 31, 32 is provided, each of which processes the measured values of the first and second humidity sensor units 10, 20 respectively, i.e. the temperatures and relative humidities captured thereby. The correction and output of the dew point temperature is carried out via a correction and output unit 34, which will be explained in more detail below. For the transmission of the output signals, particularly the dew point temperature, to a subsequent electronic system the control unit 30 also has an output interface 35, via which data can be transmitted, e.g. in a suitable digital or analog protocol.

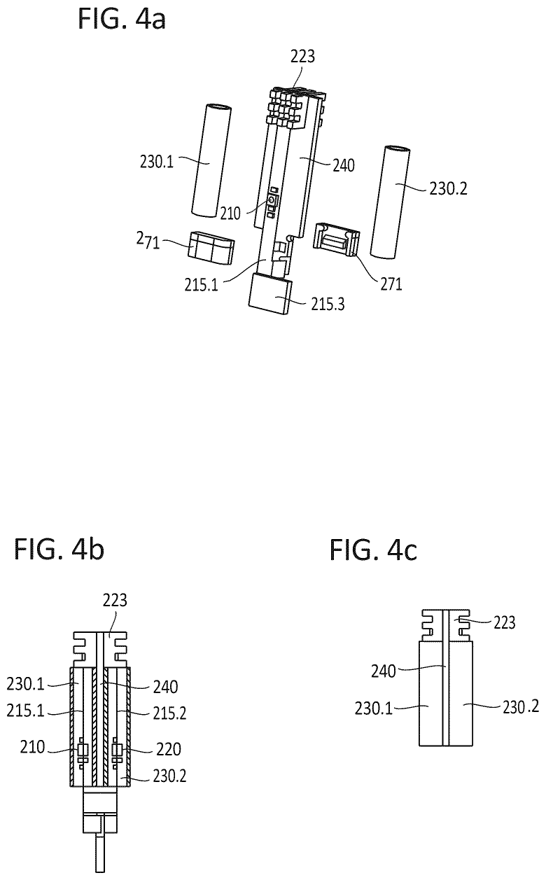

In the present example, the temperature of the first humidity sensor unit 10 is changed cyclically via the correspondingly configured and arranged control unit 30, namely it is heated cyclically and the at least one dew point correction parameter Td_{absolute} already mentioned is determined. Furthermore, the dew point correction parameter Td_{absolute} is used by the control unit 30 to correct the measured values rH2 of the second humidity sensor unit 20 and to continuously output corrected dew point temperatures Td2_{corr} based on the corrected measured values rH2_{corr}. A detailed explanation of this procedure is provided during the further description with reference to FIGS. 5-7.

With the help of the first humidity sensor unit 10, which is heated cyclically in the present example, absolute values of the relative humidity are thereby determined cyclically in an absolute measuring operating mode and used to form the dew point correction parameter Td_{absolute}. In contrast to this, the second humidity sensor unit 20 is operated permanently unheated; by measuring the temperature T2 and relative humidity rH2, the dew point temperature of interest can be continuously determined and a corrected dew point temperature Td2_{corr} can be output. The second humidity sensor unit 20 works thereby in a relative-measuring operating mode with respect to the relative humidity rH2, i.e. changes in the relative humidity rH2 are continuously resolved through it, as there is never an interruption in the measurement. The reference to the absolute value of the relative humidity, which is obtained from the first humidity sensor unit 10, is only established mathematically. As already mentioned, the dew point correction parameter Td_{absolute} determined via the first humidity sensor unit 10 is used to repeatedly correct the dew point determination of the second humidity sensor unit 20 and to output the corrected dew point temperature Td2_{corr}.

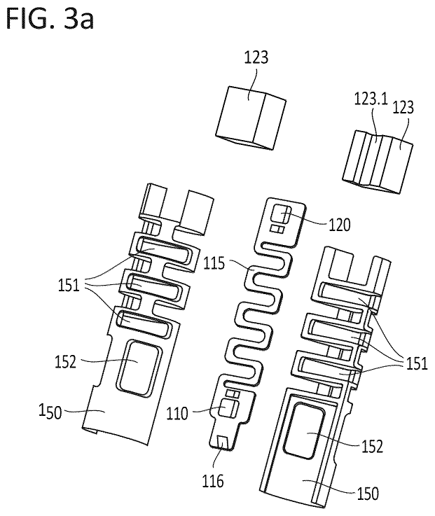

The sensor-side part of a first embodiment of the measuring device according to the present disclosure is described below with reference to FIGS. 3a-3d; this is configured as a so-called sensor probe and can therefore be used flexibly in various measuring applications. FIG. 3a shows an exploded view of this part of the measuring device, FIGS. 3b-3d show further views and/or partial views of the same.

In the example shown, the two humidity sensor units 110, 120 are configured as integrated components and/or ASICs, which are disposed at the opposite ends of an elongated carrier element 115. The carrier element 115 in this case is a circuit board, for example made of FR4 material, whereby connecting lines to the two humidity sensor units 110, 120 and/or ASICs are provided in the circuit board, via which these components are supplied with energy and via which data and control signals can be transmitted. As can be seen, the carrier element 115 is configured with reduced material in the area between the two humidity sensor units 110, 120. Specifically, the circuit board in this area consists of a meandering residual circuit board area. In this example, the thermal decoupling between the two humidity sensor units 110, 120 is ensured by such a configuration of the carrier element 115, i.e. heat transfer from the cyclically heated first humidity sensor unit 110 at the lower end of the carrier element 115 to the second humidity sensor unit 120 disposed at the upper end of the carrier element 115 is largely prevented.

In the illustrated exemplary embodiment, the second humidity sensor unit 120 is surrounded by a cooling element 123 in the form of a one or two part heat sink, via which the resulting heat from the second humidity sensor unit 120 is dissipated particularly effectively to the environment, so that the temperature of the medium to be measured has the greatest possible influence on the humidity sensor unit 120. This means that the temperature of the temperature sensor follows the temperature of the medium as closely as possible. The heat sink consists, for example, of copper or another material with good thermal conductivity and exhibits an access channel 123.1 in the form of an elongated groove; access of the ambient medium, for example air, to the second humidity sensor unit 120 is ensured via this access channel. To ensure a good thermal connection of the cooling element 123 to the carrier element 115 and/or the ASIC, the heat sink is soldered directly on the carrier element 115.

In the area below the heat sink 123, the carrier element 115 is surrounded by a cylindrical housing 150 that has several opening windows 151, 152. A somewhat larger opening window 152 is located in the area of the first humidity sensor unit 110 and thereby allows access of the ambient medium to the first humidity sensor unit 110. Further opening windows 151 in the form of narrow air slots are provided in the housing 150 adjacent to the material-reduced, central area of the carrier element 123. Here, the opening windows 151 also contribute to thermal decoupling between the two humidity sensor units 110, 120, as, due to the possible flow through the housing 150, any resulting heat can be easily dissipated at the carrier element 115.

At the lower end, the carrier element 115 also has an electrical connection 116 to transmit data and control signals between the humidity sensor units and the control unit. In an assembled state, the lower end of the carrier element 115 is thereby electrically connected to the control unit and the power supply unit via the electrical connection 116.

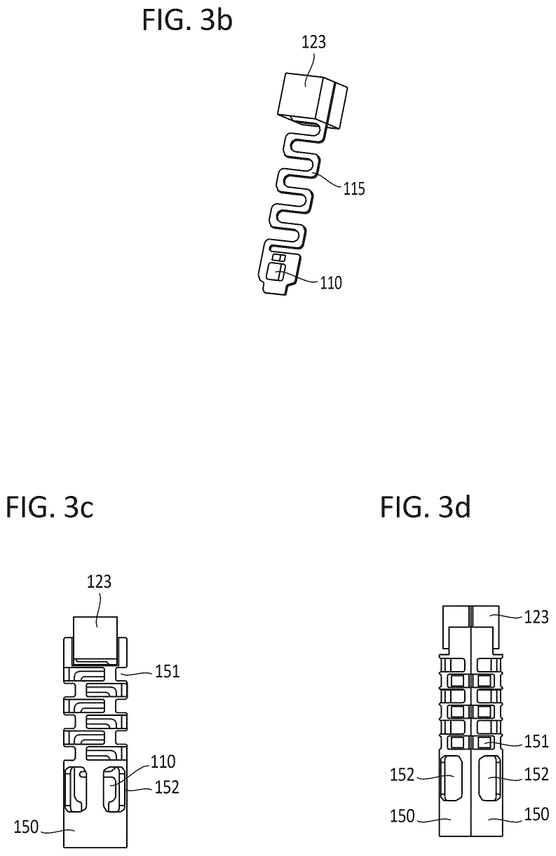

The sensor-side part of a second exemplary embodiment of the measuring device according to the present disclosure is described below with reference to FIGS. 4a-4c. FIG. 4a shows an exploded view of the device, FIGS. 4b and 4c show further views and/or partial views.

In the second exemplary embodiment, the first and second humidity sensor units 210, 220 are disposed on opposing, separate carrier elements 215.1, 215.2, which are preferably configured as thin, flexible circuit boards. In the lower area, the flexible circuit boards are connected via flexible cross-connections to a rigid carrier element area 215.3, which is formed from FR4 circuit board material. A rectangular heat-conducting shield 240 is disposed between the two carrier elements 215.1, 215.2, which dissipates the heat transferred to it by thermal radiation or heat transport in the direction of a metallic cooling element 223. In the present case, the heat conducting shield 240 is made of rigid FR4 circuit board material, which has copper surfaces on both outer sides in the area of the cooling element 230 on the circuit board material and functions there as a thermal conductor, while it is configured as a thermal insulator in between. In addition to the single-layer structure shown, a multi-layer FR4 circuit board could also act as a heat shield.

In this embodiment of the device according to the present disclosure, the thermal decoupling between the two humidity sensor units 210, 220 is thus generally ensured by the heat conducting shield 240 and the material of the two carrier elements 215.1, 215.2.

In the upper part of the measuring device, a holder is formed on the two carrier elements 215.1, 215.2 for the mechanical stability of the structure. As can be seen in FIG. 4a, the cooling element 223 is configured in the form of a metallic heat sink for this purpose. In the lower area of the device, the flexible circuit boards are connected via flexible cross-connections to a rigid carrier element area 215.3, which is formed from FR4 circuit board material. The rigid carrier element area 215.3 and the heat shield 240 are in turn well thermally decoupled from each other.

To protect the two humidity sensor units 210, 220, the respective carrier elements 215.1, 215.2 are surrounded by hollow cylindrical filter caps in the assembled state, which are permeable to the ambient medium. A PTFE sintered material, for example, can be considered as a filter cap material.

In the following, the method according to the present disclosure for determining and outputting the dew point temperature of an ambient medium is explained in more detail with reference to FIGS. 5-7.

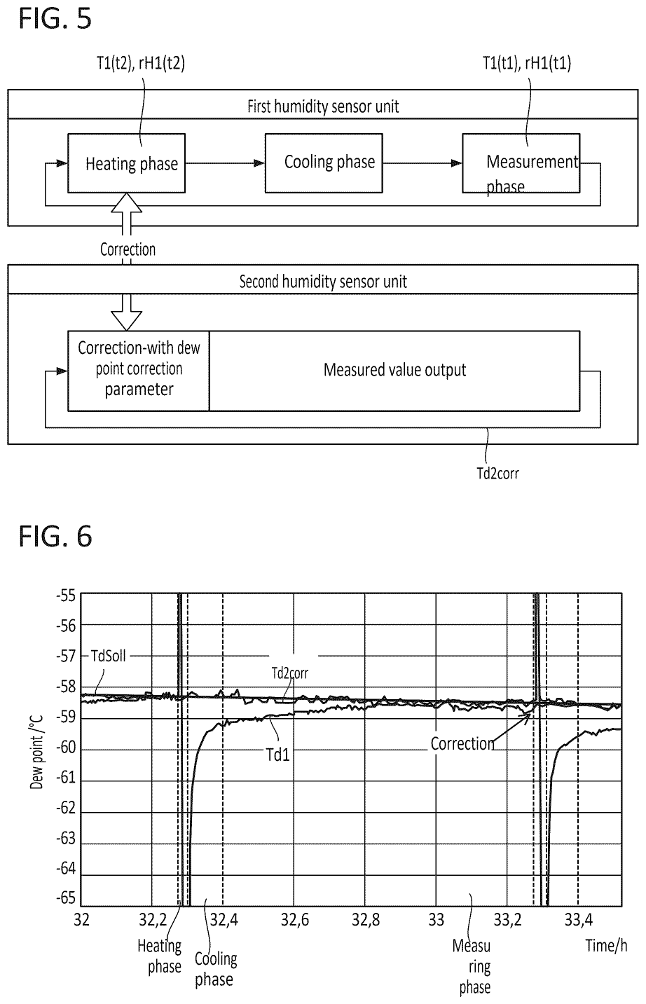

FIG. 5 illustrates the different operating phases of the two humidity sensor units of the measuring device according to the present disclosure. FIG. 6 shows the dew point temperatures determined by the humidity sensor units in the various operating phases; Td1 denotes the dew point temperature determined by the first humidity sensor unit, Td2_{corr} denotes the corrected dew point temperature continuously determined by the second humidity sensor unit, which is also output.

The various operating phases of the first humidity sensor unit are shown in the upper part of FIG. 5. These include a heating phase, a cooling phase and a measuring phase, which are preferably run through and/or repeated cyclically. In the heating phase, the first humidity sensor unit is heated to a predetermined temperature, e.g. to approx. 125° C., with the aid of the temperature change element. In the subsequent cooling phase, the cooling down to the ambient temperature takes place. Alternatively, active cooling below the ambient temperature can also be provided, e.g. with the aid of a Peltier element, for example in the case of very high ambient temperatures or very low dew point temperatures. As can be seen from FIG. 6, it is not possible to correctly determine the actual dew point temperature Td1 from the measured values (temperature, relative humidity) of the first humidity sensor unit during both the heating and cooling phases. The dew point temperature Td1 determined via the measured values of the first humidity sensor unit is clearly too high or respectively too low in these two operating phases. Only in the subsequent measuring phase does the dew point temperature Td1 determined by the first humidity sensor unit approach the actual dew point temperature Td_{target}.

The lower part of the illustration in FIG. 5 shows the behavior of the second humidity sensor unit, which operates independently of the first humidity sensor unit and remains continuously in a measuring phase, in which the current and/or corrected dew point temperature Td2_{corr} is continuously determined based on the measured values relating to temperature T2 and relative humidity rH2. The second humidity sensor unit therefore only has the measuring phase as its only operating phase. The behavior of the second humidity sensor unit, which is independent of the first humidity sensor unit, is ensured by the above-mentioned thermal decoupling of the two humidity sensor units in the measuring device according to the present disclosure. During the continuous measuring phase, the second humidity sensor unit repeatedly uses at least one dew point correction parameter determined via the first humidity sensor unit only at specific points in time to correct the ongoing dew point determination of the second humidity sensor unit and to output a corrected dew point temperature Td2_{(corr)}.

As will be explained in detail below, temperature and humidity measurements at at least two points in time t1, t2 with different temperatures T1(t1), T1(t2) are required to determine the dew point correction parameter by means of the first humidity sensor unit. The corresponding times t1, t2 are selected as close together as possible, whereby, for example, a first time t1 is at an ambient temperature (or below) in the measuring phase and a second time t2 is at an increased temperature of 125° C. in the heating phase, i.e. T1(t1)=25° C., T1(t2)=125° C.

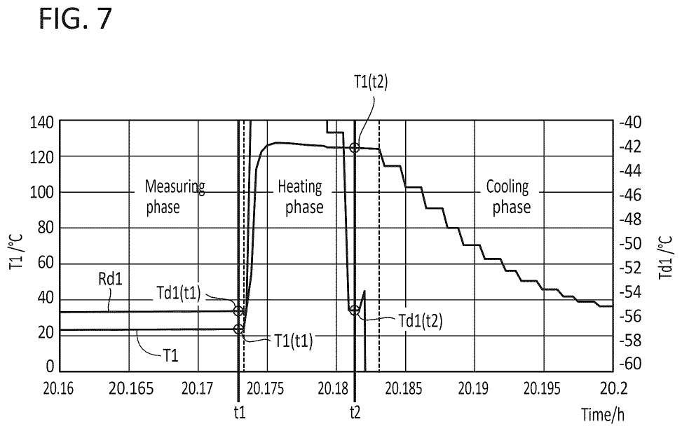

Using FIG. 7, the following procedure is exemplarily explained to demonstrate how the dew point correction parameter is determined using the first humidity sensor unit. On the one hand, the diagram shows the temporal progression of the temperature T1 measured by the first humidity sensor unit during the measuring, heating and cooling phases; on the other hand, the time curve of the dew point temperature Td1, determined from the measured temperature T1 and relative humidity rH1 of the first humidity sensor unit, is shown.

As can be seen from the Figure, the dew point temperature Td1(t1) is determined at time t1 in the measurement phase shortly before the heating phase in a known manner, e.g. using the so-called Magnus formulas, as a function f1 of the measured values for temperature T1(t1) and relative humidity rH1(t1); i.e. Td1(t1)=f1(T1(t1), rH1(T1)). With T1(t1)=25° C. and rH1(t1)=3%, the result is approximately Td1(t1)=−23.18° C.

Regarding the function f1 and/or the Magnus formulas, reference should be made to the publication by R. Dirksen, Ein einheitliches Berechnungsverfahren für die relative Feuchte am Meteorologischen Observatorium Lindenberg, MOL-RAO Aktuell, 2/2019 [A Standardized Calculation Method for the Relative Humidity at the Lindenberg Meteorological Observatory, MOL-RAO Aktuell, 2/2019]; cf. https://www.dwd.de/DE/forschung/atmosphaerenbeob/lindenbergersaeule/rao_download/aktuell_2019_02.pdf.

At the end of the heating phase, analogous to the time t2, the dew point temperature Td1(t2) is determined from the measured values T1(t2), rH1(t2); i.e. Td1(t2)=f1(T1(t2), rH1(t2)). For example, T1(t2)=125° C. and rH1(t2)=0.04% results in the dew point temperature Td1(t2)=−23.49° C.

The values determined in this way for the dew point temperatures Td1(t1) and Td1(t2) at the two temperatures T1(t1), T1(t2) are then compared. If these dew point temperatures Td1(t1), Td1(t2) are not identical—as in the present example—a first humidity correction parameter rH_{Offset_1} is determined. For this purpose, an ideal relative humidity rH1(t2)_{calc} is first determined at the higher temperature T1(t2) if the dew point temperature Td1(t1) is simultaneously assumed at the lower temperature T1(t1); i.e. rH1(t2)_{calc}=f2(T1(t2), Td1(t1). Regarding function f2, reference should also be made to the above-mentioned, well-known Magnus formulas; accordingly, the relative humidity results from the ratio of the saturation vapor pressures at the dew point temperature and the medium temperature. With the above example data, the ideal relative humidity is then rH1(t2)_{calc}=f2(125° C.,−23.18° C.)=0.0411%.

The first humidity correction parameter rH_{Offset_1} then results from the comparison of the determined ideal relative humidity rH1(t2)_{calc} and the measured relative humidity rH1(t2) at the higher temperature T1(t2) according to rH_{Offset_1}=rH1(t2)_{calc}−rH1(t2). Using the above example data, this results in rH_{Offset_1}=0.0411%−0.04%=0.0011%. The first humidity correction parameter rH_{Offset_1} is adjusted and/or updated in each cycle according to this procedure.

Using the humidity correction parameter rH_{Offset_1} determined in this way, a corrected value for the measured relative humidity rH_{1corr} is then obtained according to rH1_{corr}=rH1+rH_{Offset_1}. With the above data, the result is rH1_{corr}=0.04%+0.0011%=0.0411%

The humidity correction parameter rH_{Offset_1} is then used to calculate the absolute dew point value Td_{absolute} as the dew point correction parameter in accordance with Td_{absolute}=f1(T1, rH1_{corr})=f1(T1, rH1+rH_{Offset_1}). The dew point correction parameter Td_{absolute} thereby corresponds to the dew point value Td1(t1) at the first temperature T1(t1) after the correction. With the above values, the dew point correction parameter Td_{absolute} or absolute dew point value results in Td_{absolute}=f1(25° C., 3%+0.0011%)=−23.18° C.

The dew point correction parameter Td_{absolute} determined in this way is then used to correct the dew point determined by the second, relative-measuring humidity sensor unit. The correction is thereby carried out by an offset change of the humidity rH2 measured by the second humidity sensor unit. For this purpose, the absolute dew point and/or dew point correction parameter Td_{absolute} determined by the first humidity sensor unit is assumed to be correct and an ideal relative humidity rH2_{ideal} is determined using the measured temperature value T2 of the second humidity sensor unit in accordance with rH2_{ideal}=f2(T2, Td_{absolute}). Using the above example data and T2=25° C., this results in rH2_{ideal}=f2(25° C.,−22.18° C.)=3.0011%.

The ideal relative humidity rH2_{ideal} determined in this way is then used to determine the aforementioned offset change in the relative humidity rH2 determined by the second humidity sensor unit according to rH_{Offset_2}=rH2_{ideal}−rH2. With the example data, this results in rH_{Offset_2}=3.0011%−2%=1.0011% for a measured value rH2=2%.

In the subsequent measurements, the offset change rH_{Offset_2} determined in this way is then used to determine the corrected measured values rH2_{corr} continuously until the next correction parameter determination according to rH2_{corr}=rH2+rH_{Offset_2}. With rH2=2% and rH_{Offset_2}=1.011%, the result is rH2_{corr}=3.0011%.

The correction of the measured humidity values of the second humidity sensor unit via the offset change and/or reconciling of the second humidity correction parameter rH_{Offset_2} with the measured values rH2 can thereby also be carried out not just in a single correction step, but in several partial steps in order to avoid in this way too abrupt a change in the output dew point temperature. For example, a correction can be used for this purpose, which linearly corrects increasingly larger errors as a function of time.

The corrected dew point temperature Td2_{corr} can then be determined from the corrected measured values rH2_{corr} according to Td2_{corr}=f1(T2=25° C., rH2_{corr}=3.0011%)=−23.18° C. At the time of correction and/or compensation, the determined dew points Td1_{absolute} and Td2_{corr} of the first and second humidity sensor units are thus identical, i.e. in the present example, Td1_{absolute}=Td2_{corr}=−23.18° C. As can be seen from FIG. 6, these values drift apart again during the further measurement phase until the next correction is made and so on.

In addition to the specifically described exemplary embodiments and the alternatives explained so far, there are of course further possible embodiments within the scope of the present disclosure.

For example, instead of the capacitive humidity sensors used in the examples, it would principally also be possible to use humidity sensors in the humidity sensor units that are based on other detection principles, such as resistive humidity sensors.

Furthermore, it is of course not absolutely necessary for the two humidity sensor units to be configured as ASICs. Alternatively, they could also be constructed as separate sensors with discrete components.

There are of course also alternative possibilities of configuring the cooling element assigned to the second humidity sensor unit, i.e. it does not necessarily have to be configured in two parts. For example, a one-piece cooling element could also be used, which can be slid onto a carrier element and fixed in place by means of a clamp.

In addition, the first and second humidity sensor units can be swapped after a certain time and then each take over the functionality of the other humidity sensor unit; this would be particularly possible in the case of the second explained exemplary embodiment. Such a variant can be advantageous, for example, with regard to the temporal stability of the polymer used for capacitive humidity measurement.

Furthermore, the heating of the first humidity sensor unit does not necessarily have to occur strictly cyclically and/or periodically but can also be carried out irregularly in a suitable manner.

Furthermore, it is not absolutely necessary, as part of the method explained, for the measurements to be taken at exactly two temperatures, namely room temperature and a temperature of 125°. In principle, it would also be possible to take a measurement at a further, third temperature and use this, in addition to a first humidity correction parameter rH_{(offset_1)}, to determine a further humidity correction parameter rH_{gain_1} as a correction variable. An rH/T characteristic curve can also be recorded and then the variation of the correction parameters rH_{Offset_1}, rH_{gain_1} can be used to infer a measured dew point temperature that has the smallest deviation from the theoretical rH/T characteristic curve, etc.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A measuring device for determining and outputting a dew point temperature of an ambient medium, comprising:
a first humidity sensor unit, which is configured to determine at least one dew point correction parameter and comprises a first humidity sensor, a first temperature sensor and a temperature change element;
a second humidity sensor unit, which is configured to continuously determine a dew point temperature and comprises a second humidity sensor and a second temperature sensor; and
a controller configured and arranged to:
change a temperature of the first humidity sensor unit via the temperature change element and thereby determine the dew point correction parameter, and
use the dew point correction parameter from the first humidity sensor unit to correct measured values of the second humidity sensor unit and to continuously output corrected dew point temperatures based on the corrected measured values.

2. The measuring device according to claim 1, wherein the second humidity sensor unit is thermally coupled with a cooling element that dissipates heat from the second humidity sensor unit to an environment.

3. The measuring device according to claim 1, wherein the second humidity sensor unit is disposed thermally decoupled from the first humidity sensor unit.

4. The measuring device according to claim 3, wherein the first and second humidity sensor units are disposed at the opposite ends of a carrier, the carrier being formed with reduced material for thermal decoupling in an area between the first and second humidity sensor units, and
wherein the carrier is surrounded by a housing that has a plurality of opening windows.

5. The measuring device according to claim 3, wherein the first and second humidity sensor units are disposed on two separate carriers, wherein a heat conducting shield is disposed between the two separate carriers, and wherein the heat conducting shield is configured to dissipate heat by thermal radiation towards a heat sink connected to the heat conducting shield.

6. The measuring device according to claim 2, comprising a heat sink made of a thermally conductive material disposed on the carrier, the heat sink being adjacent to the second humidity sensor unit.

7. The measuring device according to claim 4, wherein the carrier has an electrical connection configured for connecting to the controller to transmit data and control signals between the first and second humidity sensor units and the controller.

8. The measuring device according to claim 1, wherein the first and second humidity sensor units are configured as integrated components.

9. A method for determining and outputting a dew point temperature of an ambient medium, with a first humidity sensor unit, from measured values of which at least one dew point correction parameter is determined with respect to temperature and relative humidity, and a second humidity sensor unit, from measured values of which with respect to temperature and relative humidity a dew point temperature is continuously determined and output, the method comprising:
changing a temperature of the first humidity sensor unit and determining at least one dew point correction parameter; and
using the at least one dew point correction parameter to correct measured values of the second humidity sensor unit and to continuously output corrected dew point temperatures based on the corrected measured values.

10. The method according to claim 9, wherein the changing of the temperature and determining of the at least one dew point correction parameter takes place cyclically.

11. The method according to claim 9, wherein determining the at least one dew point correction parameter includes determining, via the first humidity sensor unit at at least two defined points in time at different temperatures from the respective measured temperatures and relative humidities, the respective dew point temperatures and wherein, if the two dew point temperatures do not match, a measured value relating to relative humidity) is corrected so that the dew point temperatures match at the different respective measured temperatures.

12. The method according to claim 9, wherein determining the at least one dew point correction parameter includes determining: respective dew point temperatures from respectively measured temperatures and relative humidities at at least two defined points in time at different temperatures,
an ideal relative humidity from an ascertained dew point at a lower temperature and a measured higher temperature, and
a first humidity correction parameter from a difference between the ideal relative humidity and a measured relative humidity at the higher temperature,
the dew point correction parameter in the form of an absolute dew point value using the first humidity correction parameter, and
a second humidity correction parameter, using the absolute dew point value, the second humidity correction parameter being subsequently reconciled with the measured values relating to relative humidity of the second humidity sensor unit to form corrected measured values relating to relative humidity to output continuously corrected dew point temperatures.

13. The method according to claim 12, wherein the reconciliation of the second humidity correction parameter with the measured values of the second humidity sensor unit with respect to relative humidity is carried out incrementally.

14. The method according to claim 10, wherein the first humidity sensor unit cyclically passes through a heating phase, a cooling phase and a measuring phase and in all phases the dew point temperature is continuously determined via the second humidity sensor unit and a corrected dew point temperature is output.
